(19) United States
(12) Patent Application Publication
(10) Pub. No.: US 2014/0214959 A1
(43) Pub. Date: Jul. 31, 2014

(54) METHOD AND SYSTEM FOR MANAGING RELATIONSHIPS ON A SOCIAL NETWORKING ENVIRONMENT

(71) Applicant: Flircle, LLC, Newton, MA (US)

(72) Inventors: David S. Wolberg, Newton, MA (US); Steven Wolberg, Newton, MA (US)

(73) Assignee: Flircle, LLC, Newton, MA (US)

(21) Appl. No.: 14/163,165

(22) Filed: Jan. 24, 2014

Related U.S. Application Data
(60) Provisional application No. 61/758,058, filed on Jan. 29, 2013.

(51) Int. Cl. G06F 15/173

(52) U.S. Cl. CPC G06F 15/17306
USPC 709/204

(57) ABSTRACT

A method and system for managing relationships on a social networking environment. In particular, establishing an augmented relationship connection between a first user account and a second user account in response to the setting of a first user augmented relationship indicator and the setting of a second user augmented relationship indicator. Existence of the augmented relationship connection enables additional functionality for interaction between the first user account and the second user account within the social networking environment. However, the setting of the augmented relationship indicator by the first user to indicate the second user is not discoverable by the second user prior to the second user independently setting their own augmented relationship indicator to indicate the first user, and vice versa.

### RELATED APPLICATIONS

This application claims priority to, and the benefit of, co-pending U.S. Provisional Application 61/758,058, filed Jan. 29, 2013, for all subject matter common to both applications. The disclosure of said provisional application is hereby incorporated by reference in its entirety.

### FIELD OF THE INVENTION

The present invention relates to a social networking environment suitable for managing relationships between users, and more particularly to a system and method for establishing and implementing an augmented relationship connection between users.

### BACKGROUND OF THE INVENTION

Online or computer implemented social networking environments are often provided by an online social networking service. The social networking environment enables common-interest groups, friends, colleagues, etc. to be connected via the Internet. Users register user accounts with the networking service and create a personal profile. After registering, a first user adds accounts of additional users in order to be able to connect socially with the added users. This connection allows for the exchange of messages with the additional users and the ability to post notifications for the additional users to view.

Online or computer implemented dating services provide a dating system that allows users previously unknown to each other to connect with each other over the Internet with the objective of developing a connection or relationship of a personal or romantic nature. Conventionally, the dating service requires users to provide personal or biographical information. In most instances, the dating service requests responses to a survey to obtain additional biographical information on a user. The information collected by the dating service is then utilized to implement various algorithms or other techniques to match and introduce users within a database that are previously unknown to each other. The users may be identified and matched to each other on the basis of having similar biographical information and/or preferences such as age range, gender, location, food interests, religion, etc. Some online dating services provide additional services such as webcasts, online chat, message boards, email, etc., after the match and introduction of the two users to each other occurs.

However, both the online/computer implemented social networks and the online/computer implemented dating or matching services fail to adequately address all scenarios of relationship development and management.

### SUMMARY

There is a need for an online relationship management hub having additional functionality beyond that which is provided in conventional online social networking environments or online dating or matching services. In particular, the present invention is directed toward a solution that allows a user, having existing first degree connections with additional users, to interact with the additional users in a new and novel way, such that a relationship can develop beyond the existing “friend” connection into an augmented relationship. The present invention additionally provides a solution that at least substantially reduces each user's fear of rejection by other users with which an augmented relationship is desired. The present invention is directed toward further solutions to address these needs, in addition to having other desirable characteristics.

In accordance with an embodiment of the present invention, in one or more computing systems that collectively implement a social networking environment, a method includes maintaining a first user account for a first user in one or more data stores of the one or more computing systems. The first user account having a first user augmented relationship indicator. Additional accounts for each of the additional users are maintained in the one or more data stores of the one or more computing systems. Each of the additional accounts has a bilaterally confirmed relationship connection with the first user account in such a way as to establish a predetermined group of accounts each having first degree account connections with the account of the first user within the social networking environment. A second user account that is included in the predetermined group of accounts is maintained for a second user. The second user account has a second user augmented relationship indicator. The first user augmented relationship indicator is set to indicate the second user account. This reflects a desire of the first user to have an augmented relationship with the second user. The second user augmented relationship indicator is set to indicate the first user account. This reflects a desire of the second user to have an augmented relationship with the first user. The one or more computing systems establish an augmented relationship connection between the first user account and the second user account in response to the setting of the first user augmented relationship indicator and the setting of the second user augmented relationship indicator. Existence of the augmented relationship connection enables additional functionality for interaction between the first user account and the second user account within the social networking environment. The setting of the first user augmented relationship indicator is not discoverable by the second user prior to setting the augmented relationship indicator of the second user account to indicate the first user account.

In accordance with aspects of the present invention, the augmented relationship connection communicates existence of a romantic relationship between the first user and the second user. Alternatively, the augmented relationship connection communicates existence of an adversarial relationship between the first user and the second user. Alternatively, the augmented relationship connection communicates existence of one or more of adverse, argumentative, belligerent, clashing, combative, conflicting, contentious, disputatious, quarrelsome, disagreeable, rancorous, affable, amiable, amicable, companionable, convivial, sociable, affectionate, amorous, romantic, loving, and/or the like, relationship between the first user and the second user.

In accordance with aspects of the present invention, the accounts for the first user, the second user, and the plurality of additional users comprise a relationship status indicator. In a further embodiment, the relationship status indicator indicates one of available, unsure, or taken for each user.

In accordance with aspects of the present invention, the first user account is synchronized with a second social networking environment. In a further embodiment, the synchronization with the second social networking environment connects the first user account with user profiles of users connected to the first user in the second social networking environment. In a further embodiment, at least one of the user profiles does not have an account in the social networking environment. Alternatively, the user profiles for users not having user accounts are displayed in a first display and the user profiles for users of the predetermined group of accounts are displayed in a second display.

In accordance with aspects of the present invention, each of the user accounts are established upon receipt of instruction for each of the additional users.

In accordance with aspects of the present invention, the additional functionality includes displaying a pop-up notification window on the accounts of the first user and the second user notifying the users of the augmented relationship connection between the first user account and the second user account.

In accordance with aspects of the present invention, the first user augmented relationship indicator is set to indicate the second user account designating a label of “hinting” for the second user account as viewed by the first user account. Alternatively, one or more user accounts having a designated label of “hinting” are defined as a subgroup of the predetermined group of accounts and are managed as a distinct group of user accounts connected with the first user account. Alternatively, the first user account includes a relationship status feed display providing only information related to one or more user accounts having a designated label of “hinting”.

In accordance with aspects of the present invention, a first user favorite indicator, of the first user account, is set to designate a label of “crush” for one or more of the additional user accounts. Alternatively, the first user account includes a relationship status feed display providing only information related to one or more user accounts having a designated label of “crush”. Alternatively, one or more user accounts having a designated label of “crush” are defined as a subgroup of the predetermined group of accounts and are managed as a distinct group of user accounts connected with the first user account.

In accordance with aspects of the present invention, the first and second user accounts are designated with labels of “flirting” when the second user augmented relationship indicator is set to indicate the first user account after the first user augmented relationship indicator has been set to indicate the second user account. Alternatively, one or more user accounts having a designated label of “flirting” are defined as a subgroup of the predetermined group of accounts and are managed as a distinct group of user accounts connected with the first user account. Alternatively, the first user account includes a relationship status feed display providing only information related to one or more user accounts having a designated label of “flirting”.

In accordance with aspects of the present invention, the additional functionality includes a messaging function enabling communication via messaging between the first user account and the second user account. Alternatively, the additional functionality includes a gaming function enabling electronic game play between the first user account and the second user account.

In accordance with aspects of the present invention, the method further includes registering accounts by requesting one or more biographical information from users.

In accordance with aspects of the present invention, the social networking environment is a related-network of the second social networking environment. In a further embodiment, the social networking environment is an application of the second social networking environment. Alternatively, the social networking environment is a subgroup within the second social networking environment. Alternatively, the social networking environment is linked directly from the second social networking environment.

In accordance with aspects of the present invention, the method further includes sharing and communicating activities by user accounts on the social networking environment to the second social networking environment. In a further embodiment, the sharing and communicating occurs via a link on a user account of the social networking environment.

In accordance with an embodiment of the present invention, a system for collectively implementing a social networking environment in one or more computing systems. The system includes a first user account for a first user maintained in one or more data stores of the one or more computing systems. The first user account has a first user augmented relationship indicator. Also, the system includes a plurality of additional user accounts for additional users maintained in the one or more data stores of the one or more computing systems. Each of the additional user accounts has a bilaterally confirmed relationship connection with the first user account in such a way as to establish a predetermined group of accounts each having first degree account connections with the account of the first user within the social networking environment. A second user account is included in the predetermined group of accounts. The second user account has a second user augmented relationship indicator. The first user augmented relationship indicator is set to indicate the second user account which reflects a desire of the first user to have an augmented relationship with the second user. The second user augmented relationship indicator is set to indicate the first user account, which reflects a desire of the second user to have an augmented relationship with the first user. An augmented relationship connection is established by the one or more computing systems between the first user account and the second user account in response to the setting of the first user augmented relationship indicator and the setting of the second user augmented relationship indicator. Existence of the augmented relationship connection enables additional functionality for interaction between the first user account and the second user account within the social networking environment. The setting of the first user augmented relationship indicator is not discoverable by the second user prior to setting the augmented relationship indicator of the second user account to indicate the first user account.

### BRIEF DESCRIPTION OF THE FIGURES

These and other characteristics of the present invention will be more fully understood by reference to the following detailed description in conjunction with the attached drawings, in which:

FIG. 1 is a system for managing user accounts and establishing an augmented relationship connection between at least two user accounts within a social networking environment according to an embodiment of the present invention;

FIG. 2 is a flow chart diagram illustrating a method of establishing an augmented relationship connection between at least two user accounts in a social networking environment according to an embodiment of the present invention;

FIGS. 3A-3C are computer displays illustrating the initial process of registering an account for users on a social networking environment according to one aspect of the present invention;

FIG. 4A is a computer display illustrating how a first user account designates “hints” with respect to a second user account according to one aspect of the present invention;

FIG. 4B is a computer display illustrating how a user account manages the accounts that the first user account has designated with “hints” according to one aspect of the present invention;

FIG. 5A is a computer display illustrating a pop-up notification window that an augmented relationship connection between a first user account and a second user account has been established according to one aspect of the present invention;

FIG. 5B is a computer display illustrating how a first user account manages the accounts that the first user account has an augmented relationship connection with according to one aspect of the present invention;

FIGS. 6A-6B are computer displays illustrating the establishment of an electronic game between two accounts that have the augmented relationship connection according to one aspect of the present invention;

FIG. 7A is a computer display illustrating how a first user account designates “crush” with respect to a second user account according to one aspect of the present invention;

FIGS. 7B-7C are computer displays illustrating how a first user account manages the accounts that the first user account has designated with “crush” according to one aspect of the present invention;

FIGS. 8A-8B are computer displays illustrating how a user adds biographical information to the user account that is viewed by additional user accounts according to one aspect of the present invention; and

FIG. 9 is a schematic view of a computing device or system, suitable for implementing the systems and methods of the present invention.

### DETAILED DESCRIPTION

An illustrative embodiment of the present invention relates to a system and method for collectively implementing a social networking environment on one or more computing systems. More specifically, the system and method of the present invention provides a relationship management hub in the form of a computer implemented social networking environment. Users having accounts within the social networking environment are able to link with each other to form connections. Users that have connected user accounts indicating existing relationships, i.e., friends, are provided with additional functionally.

Specifically, a first user can set their augmented relationship indicator on their first user account to indicate (i.e., point to, identify, etc.) a second user account of a second user to whom the first user account is already previously connected. The setting of the augmented relationship indicator is a reflection of the first user's desire to have an augmented relationship with the second user (i.e., a closer relationship, a romantic relationship, or perhaps alternatively an adversarial relationship such as a debate or argument). Once the augmented relationship indicator is set by the first user, neither the second user, nor any other user of the social networking environment (save, perhaps, an administrator function) can discover this setting of the augmented relationship indicator unless a corresponding indicator is set as described below. Said differently, the indication by the first user of the desire for the augmented relationship with the second user remains entirely secret to everyone without further independent action by the second user.

Then, should the second user independently also desire an augmented relationship with the first user, the second user can set their augmented relationship indicator to indicate (i.e., point to, identify, etc.) the first user account of the first user.

Upon two users independently setting their own augmented relationship indicators to indicate the other of the two users, without each user being able to discover the setting of the other user prior to setting their own indicators, an augmented relationship connection is then established between the first user account and the second user account. The augmented relationship connection is only then revealed to both the first user and the second user that the other of the two users has made a similar indication. Existence of the augmented relationship connection enables additional functionality for interaction between the first user account and the second user account within the social networking environment (i.e., game playing, messaging, chatting, etc. in either private or public feeds).

Should the second user never set their augmented relationship indicator to indicate the first user, then the first user can surmise that the second user does not have an interest in an augmented relationship with the first user. This result is achieved without necessitating that the first user actually approach the second user outside of the social networking environment and propose an augmented relationship, only to be rejected by the second user, thus substantially reducing the fear of rejection for the first user. In social situations, where the two users are already friends, such a rejection can be problematic to the continued friendship. Thus, by both users that are pre-existing friends having pre-existing friend connections in the social networking environment, and by making use of the secretive augmented relationship indicator functionality of the present invention, disruptive or awkward social situations between and within pre-existing friend connections are avoided. It should be noted that the requirement of the existing friend connection is a pre-condition to each user being able to set the augmented relationship indicator.

As such, the present invention differs from a conventional online social networking environments at least in that the ability to secretly indicate a desire for a different relationship with an existing user/friend connection is provided. In addition, the present invention differs from conventional dating or matching systems and methods in that such conventional systems are designed to introduce or match two users that previously were not connected with each other as friends, and based on collection of extensive personal information and implementation of various matching algorithms in an attempt to identify two users that should like each other.

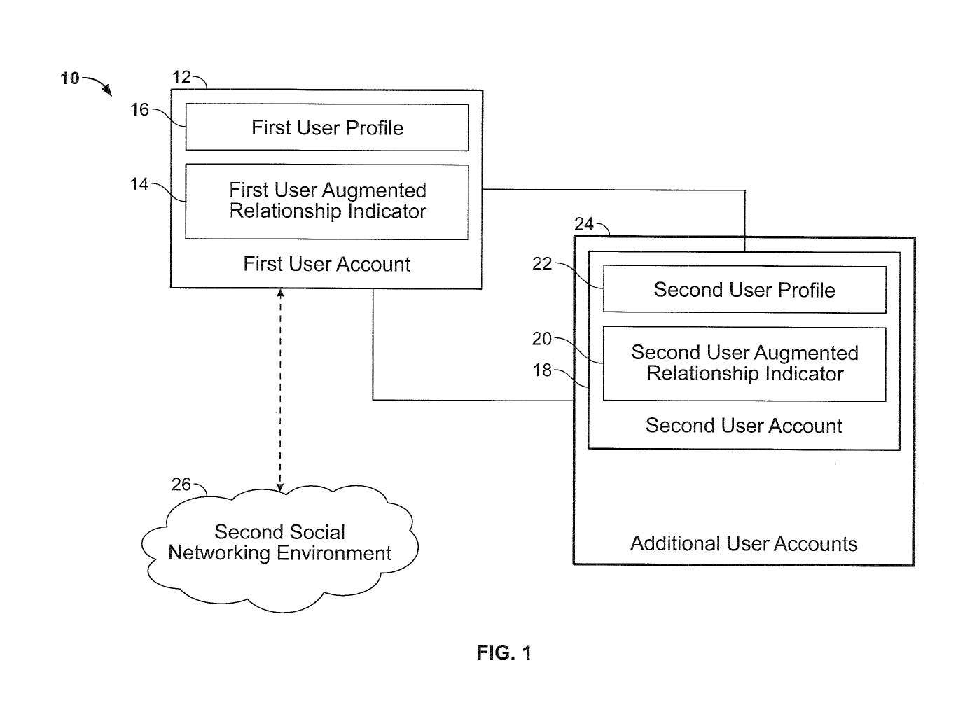

FIGS. 1 through 9, wherein like parts are designated by like reference numerals throughout, illustrate example embodiments of a social networking environment according to the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed in a manner still in keeping with the spirit and scope of the present invention.

FIG. 1 depicts a system 10 for managing user accounts and establishing an augmented relationship connection between at least two user accounts 12, 18 within a social networking environment.

The system 10 includes a first user account 12 for a first user. The first user account 12 is maintained in one or more data stores of one or more computing systems. The first user account 12 has a first user augmented relationship indicator 14 and a first user profile 16. The first user profile 16 is a display of the first user account 12 on the social networking environment. For example, the first user profile 16 displays a photograph of the first user and biographical information regarding the first user. The first user augmented relationship indicator 14 is used to indicate (i.e., point to, identify, etc.) another user account to whom the first user account 12 is already previously connected. The setting of the first user augmented relationship indicator 14 is a reflection of the first user's desire to have an augmented relationship with another user.

The system 10 also includes additional user accounts 24 for additional users. These additional user accounts 24 are maintained in one or more data stores of one or more computing systems. Each of the additional user accounts 24 has a bilaterally confirmed relationship connection with the first user account 12 in such a way as to establish a predetermined group of accounts 24 each having first degree account connections with the first user account 12 within the social networking environment.

In one optional example, as shown in FIG. 1, the first user account 12 is synchronized with a second social networking environment 26. The synchronization with the second social networking environment 26 connects the first user account 12 with user profiles of users connected to the first user in the second social networking environment 26.

A second user account 18 is included in the predetermined group of accounts 24. The second user account 18 has a second user augmented relationship indicator 20 and a second user profile 22. The second user profile 22 is a display of the second user account 18 on the social networking environment. For example, the second user profile 22 displays a photograph of the second user and biographical information regarding the second user. The second user augmented relationship indicator 20 is used to indicate (i.e., point to, identify, etc.) another user account to whom the second user account 18 is already previously connected. The setting of the second user augmented relationship indicator 20 is a reflection of the second user's desire to have an augmented relationship with another user.

In one example, the first user augmented relationship indicator 14 is set to indicate the second user account 18 which reflects a desire of the first user to have an augmented relationship with the second user. The second user augmented relationship indicator 20 is set to indicate the first user account 12, which reflects a desire of the second user to have an augmented relationship with the first user. An augmented relationship connection is established by the one or more computing systems between the first user account 12 and the second user account 18 in response to the setting of the first user augmented relationship indicator 14 and the setting of the second user augmented relationship indicator 20. Existence of the augmented relationship connection enables additional functionality for interaction between the first user account 12 and the second user account 18 within the social networking environment.

The setting of the first user augmented relationship indicator 14 is not discoverable by the second user prior to setting the second user augmented relationship indicator 20 to indicate the first user account 12. Alternatively, the setting of the second user augmented relationship indicator 20 is not discoverable by the first user prior to setting the first user augmented relationship indicator 14 to indicate the second user account 18

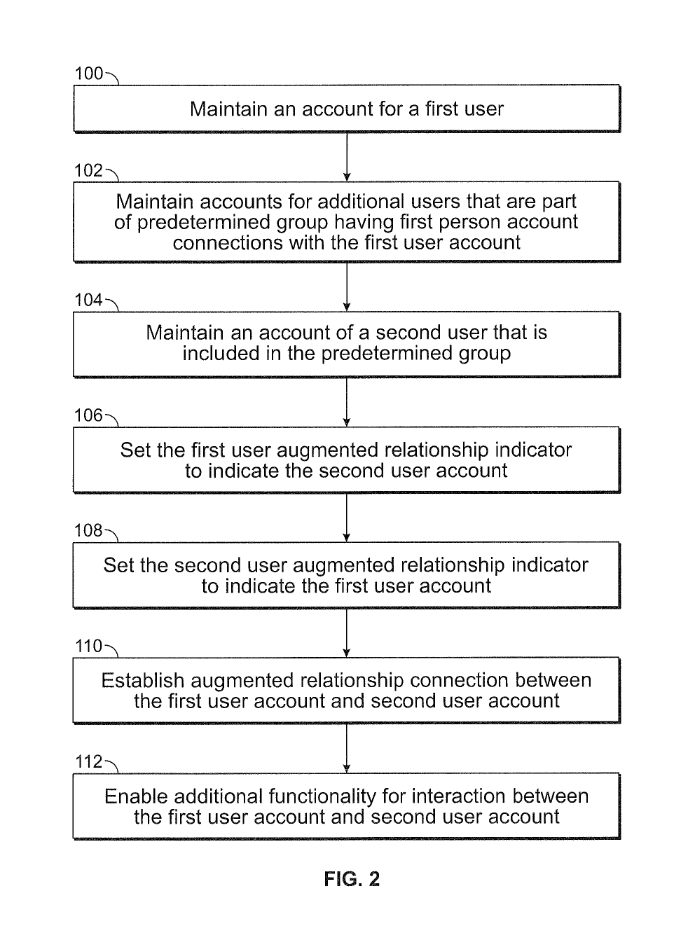

FIG. 2 depicts a method according to an example embodiment of the present invention for managing relationships between user accounts 12, 18 on a social networking environment.

A first user account 12 for a first user is maintained on one or more data stores of one or more computing systems (step 100). The first user account 12 has a first user augmented relationship indicator 14.

Accounts 24 for additional users are maintained in the one or more data stores of the one or more computing systems (step 102). These additional user accounts 24 have a bilaterally confirmed relationship connection with the first user account 12. This bilaterally confirmed relationship is considered to be a predetermined group of accounts each having first degree account connections with the first user account 12 within the social networking environment. In one example, the bilaterally confirmed relationship is a one-to-many relationship between the first user account 12 and the additional user accounts 24.

A second user account 18 is maintained and included in this predetermined group of accounts 24 (step 104). The second user has a second user augmented relationship indicator 20.

In step 106, the first user augmented relationship indicator 14 is set to indicate the second user account 18. This reflects a desire of the first user to have an augmented relationship with the second user. In one example, the first user augmented relationship indicator 14 is a first user flag. The first user flag is raised in a database against the first user account 12 for the second user account 18. This raising of the first user flag is an example embodiment of step 106.

In step 108, the second user augmented relationship indicator 20 is set to indicate the first user account 12. This reflects a desire of the second user to have an augmented relationship with the first user. In one example, the second user augmented relationship indicator 20 is a second user flag. The second user flag is raised in a database against the second user account 18 for the first user account 12. This raising of the second user flag is an example embodiment of step 108.

One or more computing systems establish an augmented relationship connection between the first user account 12 and the second user account 18 (step 110). This augmented relationship connection is in direct response to the setting of the first user augmented relationship indicator 14 and the setting of the second user augmented relationship indicator 20. In one example, the establishment of the augmented relationship connection is due to both the first user flag and second user flag being raised. The existence of the augmented relationship connection enables additional functionality for interaction between the first user account 12 and the second user account 18 within the social networking environment (step 112). When the augmented relationship connection is established, additional functionality occurs such as the connection is revealed to the first user and the second user (step 112).

This augmented relationship connection only occurs when both the first user augmented relationship indicator 14 is set to the second user account 18 and the second user augmented relationship indicator 20 is set to the first user account 12. Prior to both users setting their respective augmented relationship indicators 14, 20 to each other, if only one of the two is set it remains secret or undiscoverable until and unless the other of the two is also set and both indicators point to or indicate the other of the two users. The order in which these two actions occur does not have any impact with respect to the overall result of establishing the augmented relationship connection. Said differently, the setting of the first user augmented relationship indicator 14 is not discoverable by the second user until the augmented relationship connection is established. Alternatively, the setting of the second user augmented relationship indicator 20 is not discoverable by the first user until the augmented relationship connection is established.

In one example, the augmented relationship connection communicates the existence of a romantic relationship between the first user and the second user. Alternatively, the augmented relationship connection communicates the existence of an adversarial relationship between the first user and the second user. In alternative examples, the augmented relationship connection communicates the existence of one or more of the following relationship characteristics: adverse, argumentative, belligerent, clashing, combative, conflicting, contentious, disputatious, quarrelsome, disagreeable, rancorous, affable, amiable, amicable, companionable, convivial, sociable, affectionate, amorous, romantic, and/or loving between the first user and second user. Those of skill in the art will appreciate that any number of different augmented relationships are possible between two users. The preceding is merely illustrative of a number of such different augmented relationship types, but is by no means a complete list and is in no way limiting of the present invention. Equivalent or other relationship types that can be implemented between users are anticipated by the present invention.

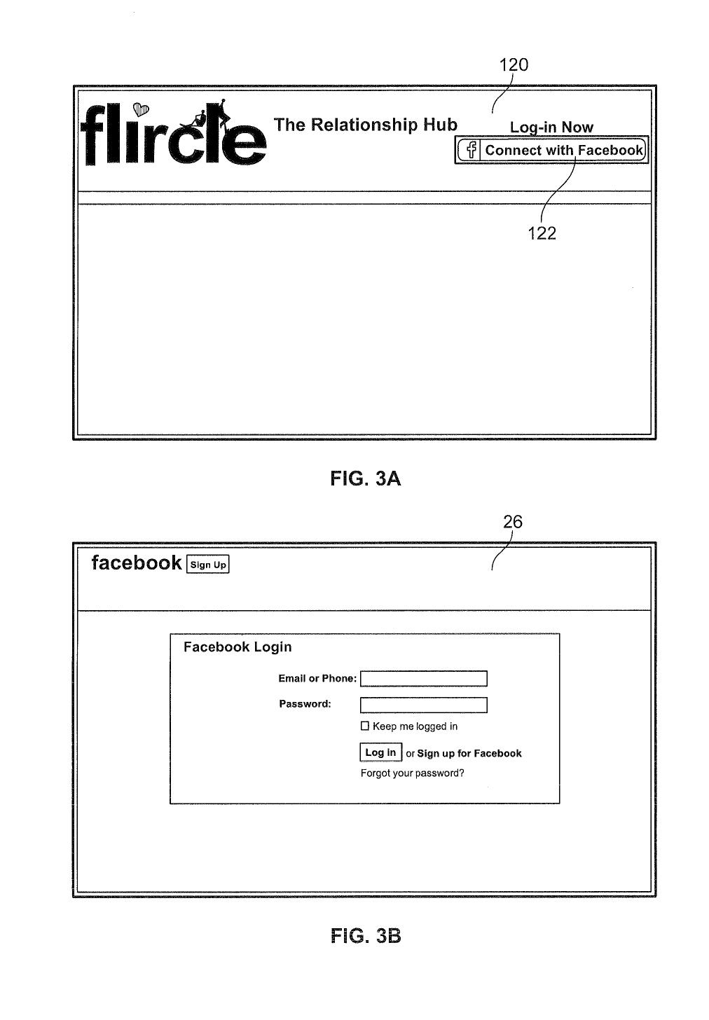

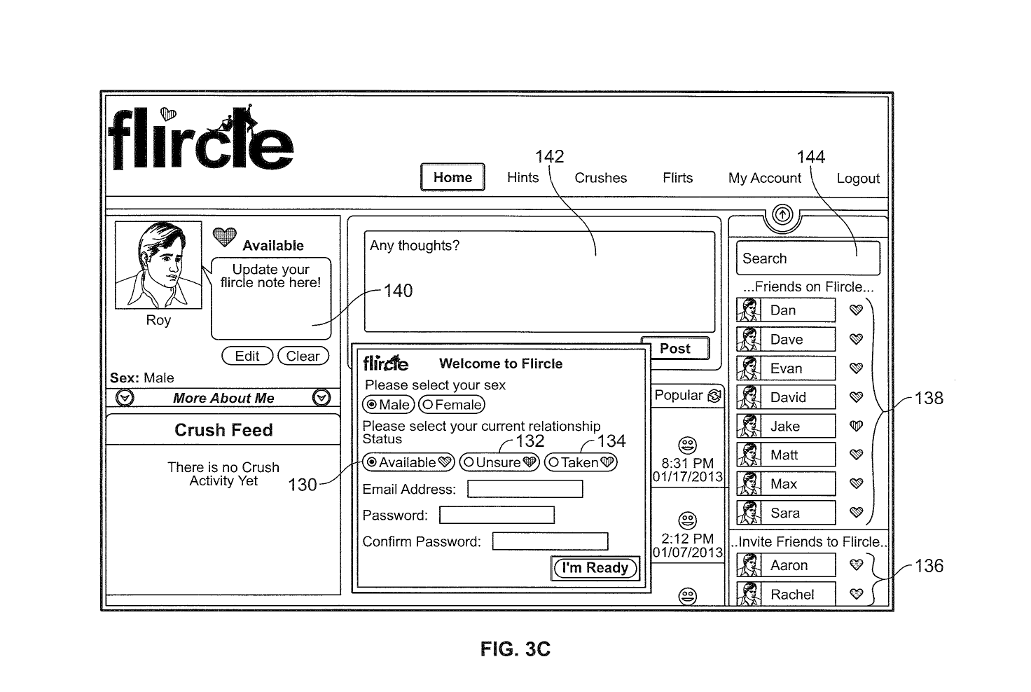

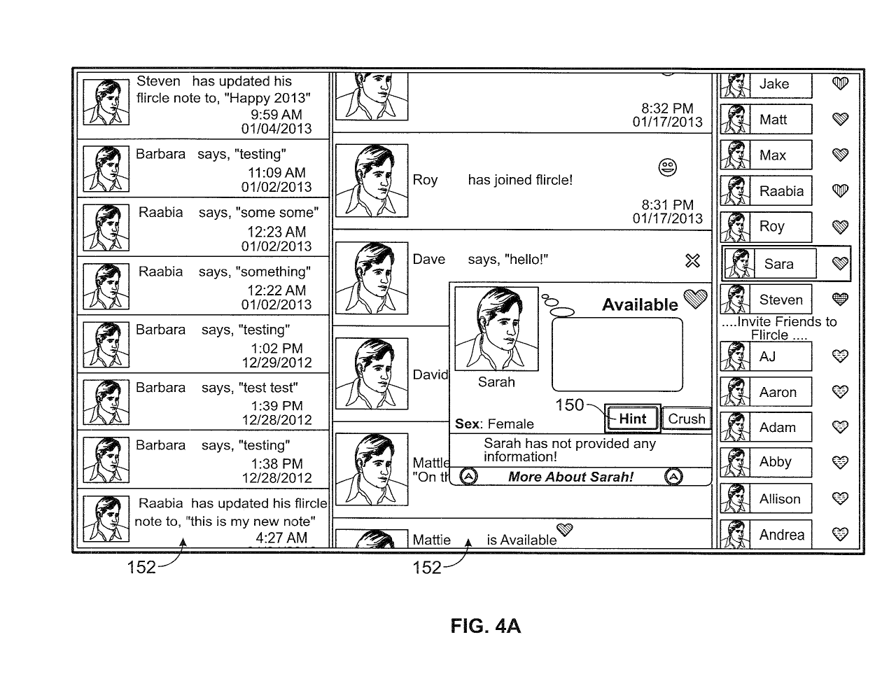

FIGS. 3A-3C depict computer displays illustrating the initial process of registering an account for users on a social networking environment.

In FIG. 3A, a user initially registers on a webpage 120 of a website that is hosting the social networking environment by clicking on a link such as “log-in Now” 122. In one example, the “log-in Now” link 122 is connected directly to a second social networking environment 26. In a further example, as shown in FIGS. 2A-2B, the second social networking environment 26 is the Facebook® online social network.

In FIG. 3B, a first user logs into the second social networking environment 26. The first user implements synchronization between the social networking environment and the second social networking environment 26. The synchronization connects the first user account 12 that is being registered in the social networking environment with that same first user's account in the second social networking environment 26. Upon establishing this connection, user profiles of users connected to the first user in the second social networking environment 26 can be imported into the social networking environment. Upon importing the user profiles from the second social networking environment 26 to the social networking environment, the first user now has a combination of connections with other user accounts 24 in social networking environment and connections with only user profiles in instances where the users associated with those user profiles have not independently created user accounts in the social networking environment. After the first importation of user profiles from the second social networking environment 26 to the social networking environment, subsequent synchronizations of this process can be implemented, as understood by those of skill in the art. The subsequent synchronizations can result in importation of additional user profiles (if the first user has added friend connections in the second social networking environment 26) and/or with the coupling of user profiles with newly opened accounts by the associated users within the social networking environment.

In one example, the social networking environment is a related-network of the second social networking environment 26. More particularly, the social networking environment is an application of the second social networking environment 26. Alternatively, the social networking environment is a subgroup within the second social networking environment 26. Alternatively, the social networking environment is linked directly from the second social networking environment 26.

Alternatively, the social networking environment does not synchronize with a second social networking environment 26. In this example, the first user adds connections to accounts of additional users to the first user account 12. The adding of connections to accounts forms a predetermined group of accounts 24 each having first degree account connections with the first user account 12 within the social networking environment.

FIG. 3C depicts a final step in the registration process requesting biographical information from the users. In this example, the users are requested to select sex: male or female. Also, the users are requested to select a relationship status indicator such as “current relationship status.” In this example, the relationship status indicator is selected from labels of “Available” 130, “Unsure” 132, or “Taken” 134. Also, users are requested to provide an email address and password. Once the user has a registered account, the user account is given an account identification. The account identification is used as an identifier for each user account. The user accounts are stored on one or more data stores such as databases. It should be noted there that because the present invention is distinct from conventional dating/matching services, there is no need to survey and collect extensive personal information from each user to enable the functionality and utility of the present invention.

In one example, at least one of the user profiles connected to the first user via the second social networking environment 26 does not have an account in the social networking environment. As shown in FIG. 3C, the user profiles for users not having user accounts are displayed in a first display and the user profiles for users of the predetermined group of accounts are displayed in a second display. In this example, the first display is labeled “Invite Friends to Flircle” 136 and the second display is labeled “Friends on Flircle” 138.

A user can perform various activities through the user account in the social networking environment. These activities include updating a note 140 or posting a message 142 on the user account as displayed in FIG. 3C. Also, a user can use a search bar 144 for searching for specific user accounts within the predetermined group of accounts.

In one example, activities by user accounts on the social networking environment are shared and communicated to the second social networking environment 26. In particular, this sharing and communicating occurs via a link on a user account of the social networking environment. One option includes the link as part of a share button on the user account that enables the user to communicate activities, such as messages, status, newsfeeds, or the like, to the second social networking environment 26.

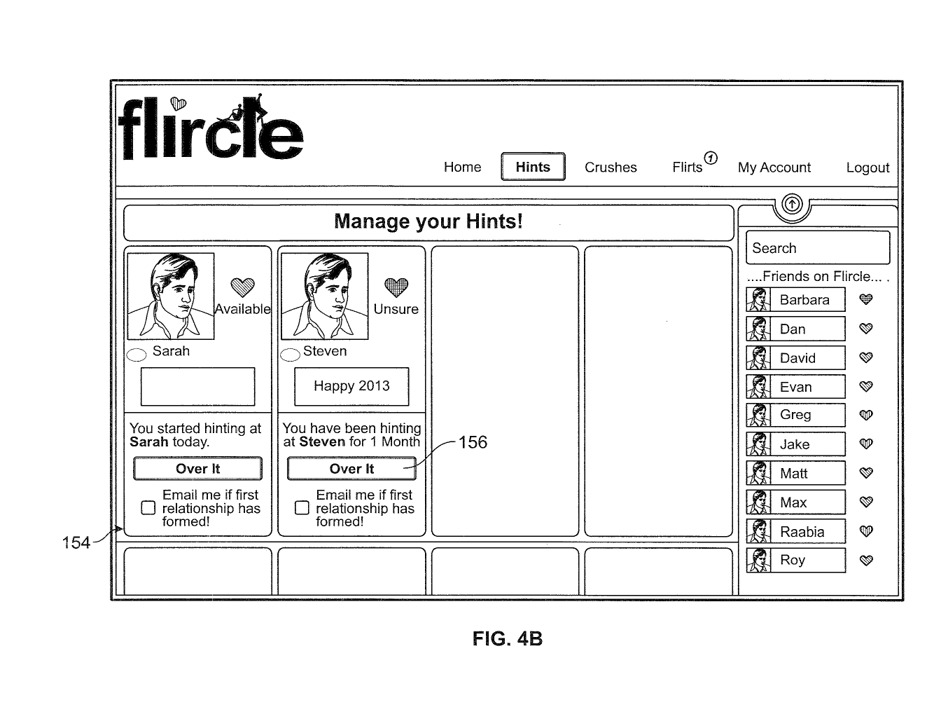

FIG. 4A depicts a computer display illustrating how a first user account 12 designates “hint” with respect to a second user account 18. Designating “hint” is performed via step 106 where the first user augmented relationship indicator 14 is set to indicate the second user account 18. Step 106 designates a label of “hinting” for the second user account 18 as viewed by the first user account 12. In one example, the user clicks on a “hint” link 150 to cause step 106 to occur. The first user account 12 has a relationship status feed display 152 providing only information related to the user accounts having the designated label of “hinting.” In this example, as shown in FIG. 4A, this relationship status feed display 152 allows a first user to follow notes or posts in a newsfeed fashion of “hinting” accounts.

FIG. 4B depicts how a first user account 12 manages the accounts that the first user account 12 has designated with “hint.” In this example, the user accounts that have a designated label of “hinting” 154 are defined and shown as a subgroup of the predetermined group of accounts. These “hinting” accounts 154 are managed as a distinct group of user accounts connected with the first user account 12. Also, as shown in FIG. 4B, a first user can unset (or reset) the first user augmented relationship indicator 14 with respect to the second user account 18. In this example, the first user clicks on the “Over It” link 156 to unset (or reset) the first user augmented relationship indicator 14 with respect to a particular user.

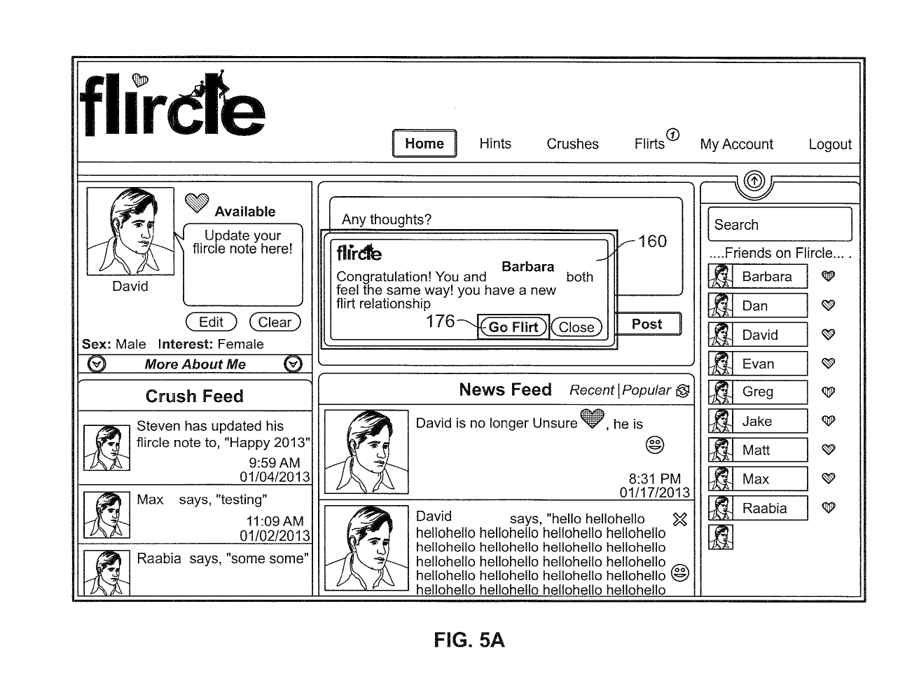

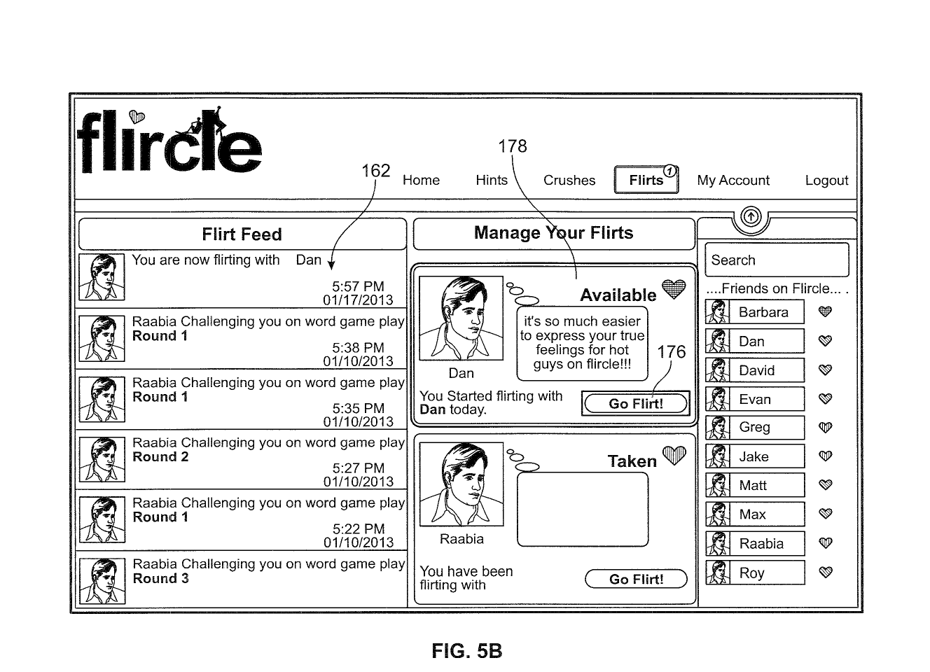

FIG. 5A illustrates a pop-up notification window 160 that an augmented relationship connection between a first user account 12 and a second user account 18 has been established. The pop-up notification window 160 is one example of an additional functionality. In this example, the augmented relationship connection is displayed as a “flirt relationship.” The augmented relationship connection has occurred since the first user augmented relationship indicator 14 was set to the second user account 18 and the second user augmented relationship indicator 20 was set to the first user account 12.

FIG. 5B illustrates how a first user account 12 manages the accounts with which the first user account 12 has an augmented relationship connection.

Designating an augmented relationship connection, such as a “flirt relationship” for example, is performed via step 110 where the augmented relationship connection is established between the first user account 12 and the second user account 18. Step 110 designates a label of “flirting” for the first user account 12 and the second user account 18. The first user account 12 has a relationship status feed display 162 providing only information related to the user accounts having a designated label of “flirting.” In this example, as shown in FIG. 5B, this relationship status feed display 162 allows a first user to follow notes or posts in a newsfeed fashion of “flirting” accounts.

In one example, the user accounts that have a designated label of “flirting” are defined and shown as a subgroup of the predetermined group of accounts. These “flirting” accounts are managed as a distinct group of user accounts connected with the first user account 12. A first user can unset (or reset) the first user augmented relationship indicator 14 with respect to the second user account 18. Alternatively, the second user can unset (or reset) the second user augmented relationship indicator 20 with respect to the first user account 12. This causes the augmented relationship connection to end or be cancelled. In this example, either user clicks on the “Over It” link 156 to unset the user augmented relationship indicator 14, 20 with respect to a particular user.

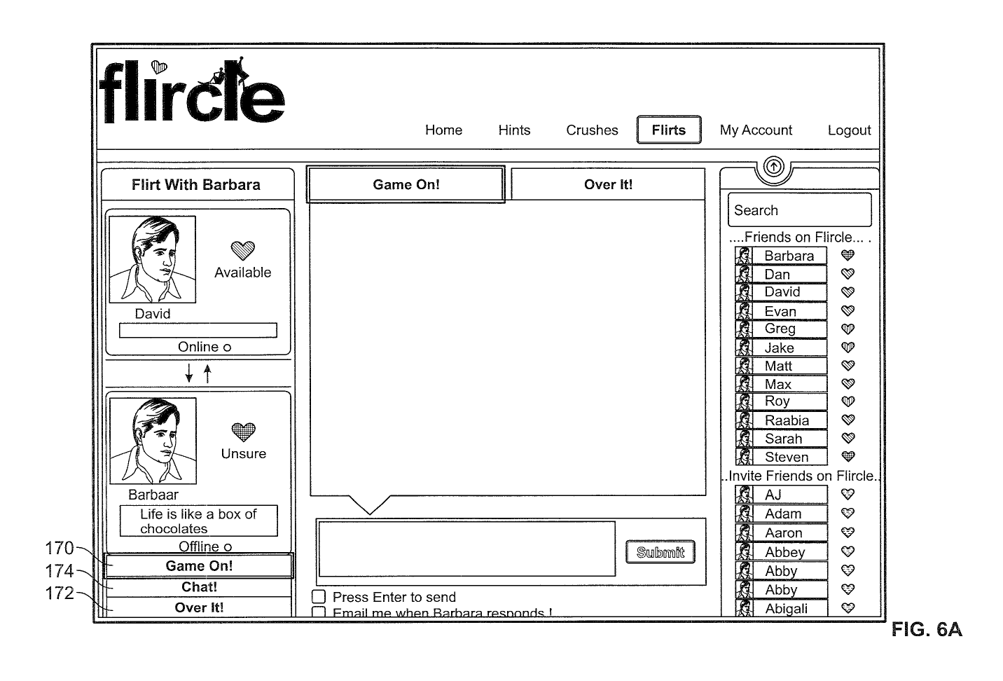

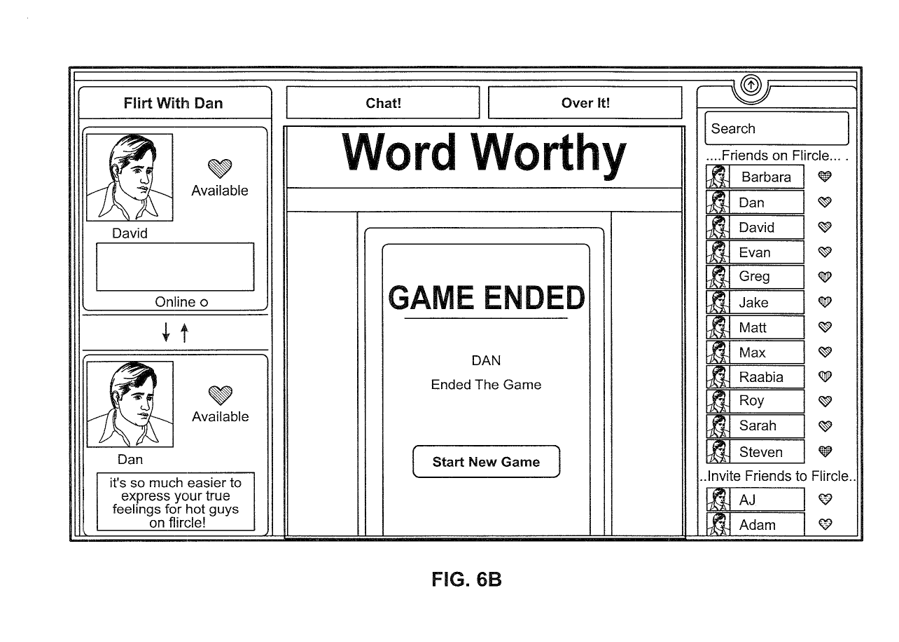

FIGS. 6A-6B illustrate the establishment of an electronic game between two accounts that have the augmented relationship connection.

The augmented relationship connection enables additional functionality interaction between the first user account 12 and the second user account 18. In this example, as shown in FIG. 6A, the additional functionality interaction takes the form of a gaming function providing an ability to play electronic games between the first user account 12 and the second user account 18. The electronic game is established by a user clicking on the link “Game On!” 170. The electronic game is cancelled by a user clicking on the link “Over It!” 172. In this example, messaging is enabled between the two accounts before, during, or after the electronic game has been established. In this example, messaging is enabled by a user clicking on the link “Chat!” 174.

In addition or alternatively, the additional functionality interaction takes the form of a messaging function providing an ability to communicate privately via messaging between the first user account 12 and the second user account 18. This private messaging is shown in FIG. 5B as a “flirt” message 178, which is enabled by clicking on the “Go Flirt” link 176. Also, this private messaging is enabled in FIGS. 6A-6B by clicking on the “Chat!” link 174.

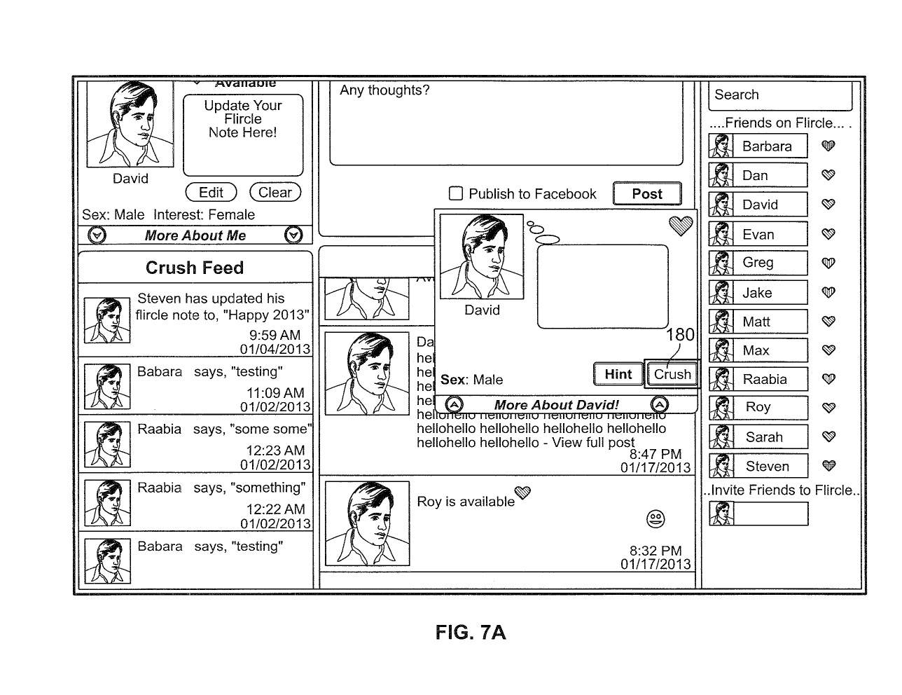

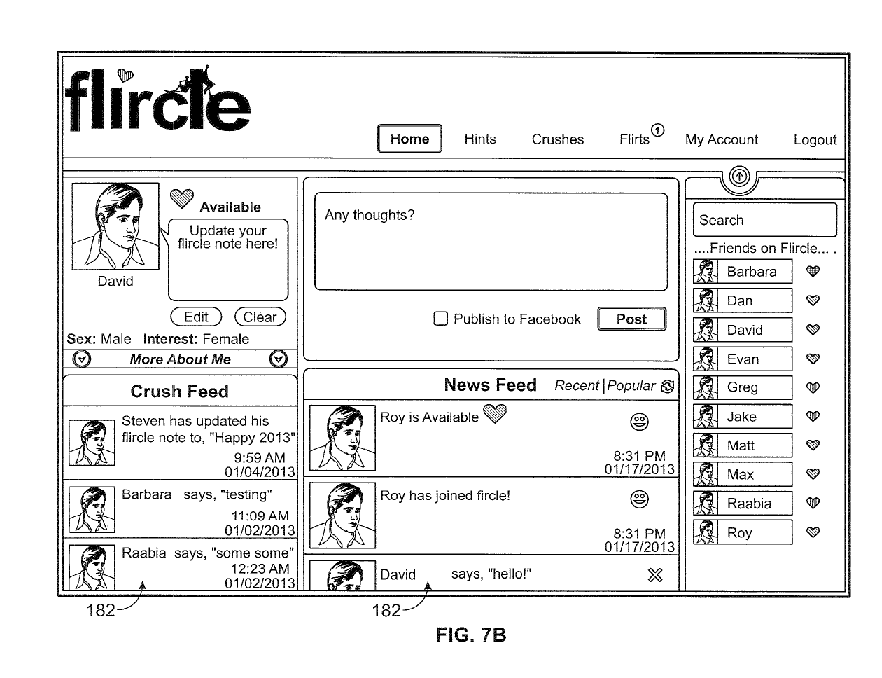

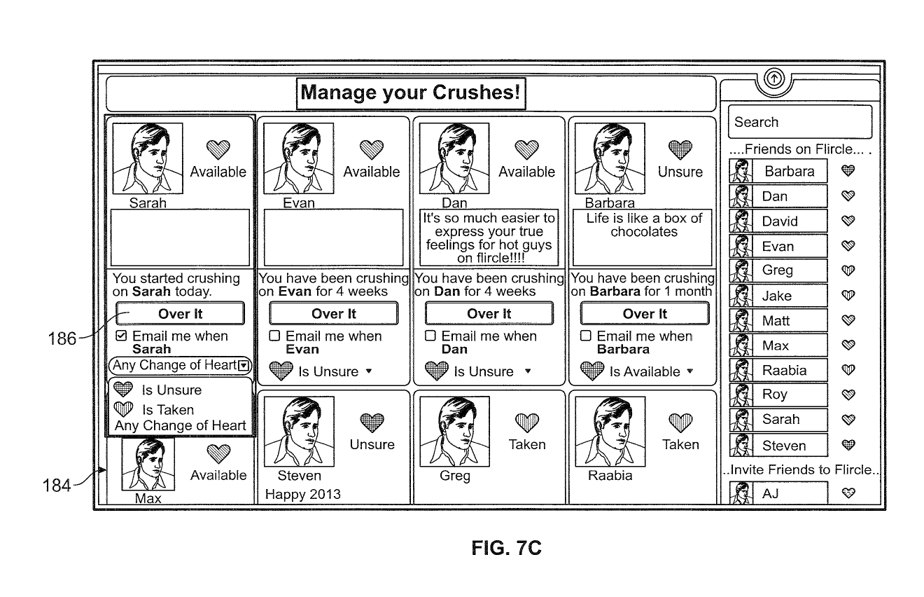

FIG. 7A illustrates how a first user account 12 designates “crush” with respect to a second user account 18. In this example, the first user account 12 has a first user favorite indicator similar to first user augmented relationship indicator 14. The first user favorite indicator is set to designate a label of “crush” for one or more of the additional user accounts 24 as viewed by the first user account 12. In one example, the first user clicks on a “crush” link 180 to cause the setting of the first user favorite indicator with respect to a second user account 18.

FIGS. 7B-7C illustrate how a first user account 12 manages the accounts that the first user account 12 has designated with “crush.”

In FIG. 7B, the first user account 12 has a relationship status feed display 182 providing only information related to the user accounts having a designated label of “crush.” In this example, this relationship status feed display 182 allows a first user to follow notes or posts in a newsfeed fashion of “crush” accounts.

In FIG. 7C, the user accounts that have a designated label of “crush” 184 are defined and shown as a subgroup of the predetermined group of accounts. These “crush” accounts 184 are managed as a distinct group of user accounts connected with the first user account 12. Also, as shown in FIG. 7C, a first user can unset the first user favorite indicator with respect to the second user account 18. In this example, the first user clicks on the “Over It” link 186 to unset the first user favorite indicator with respect to a particular user.

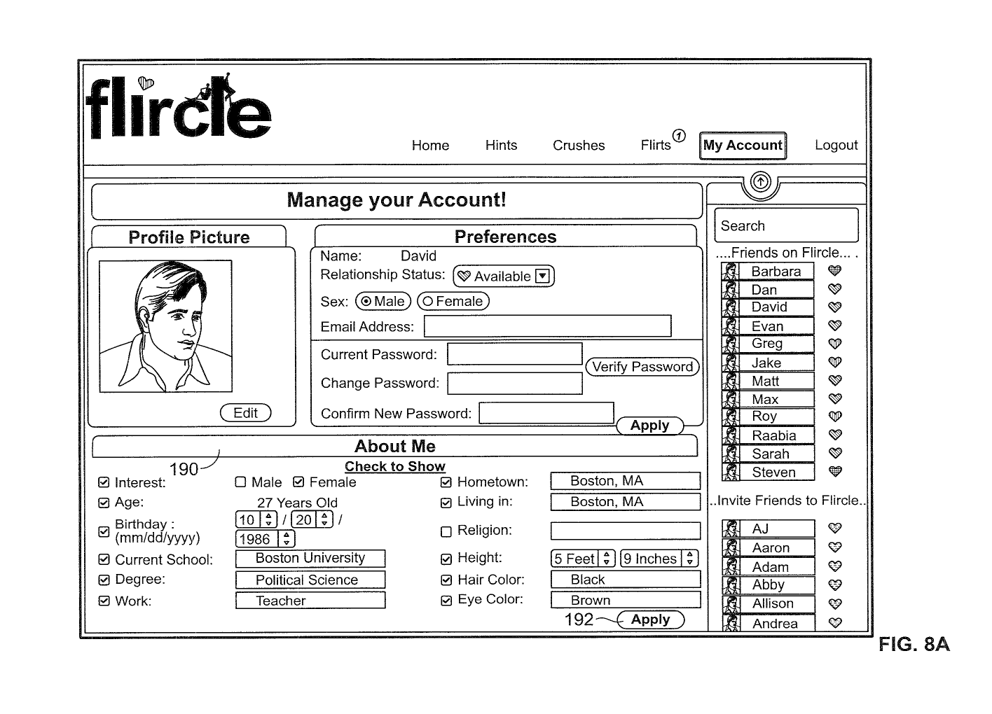

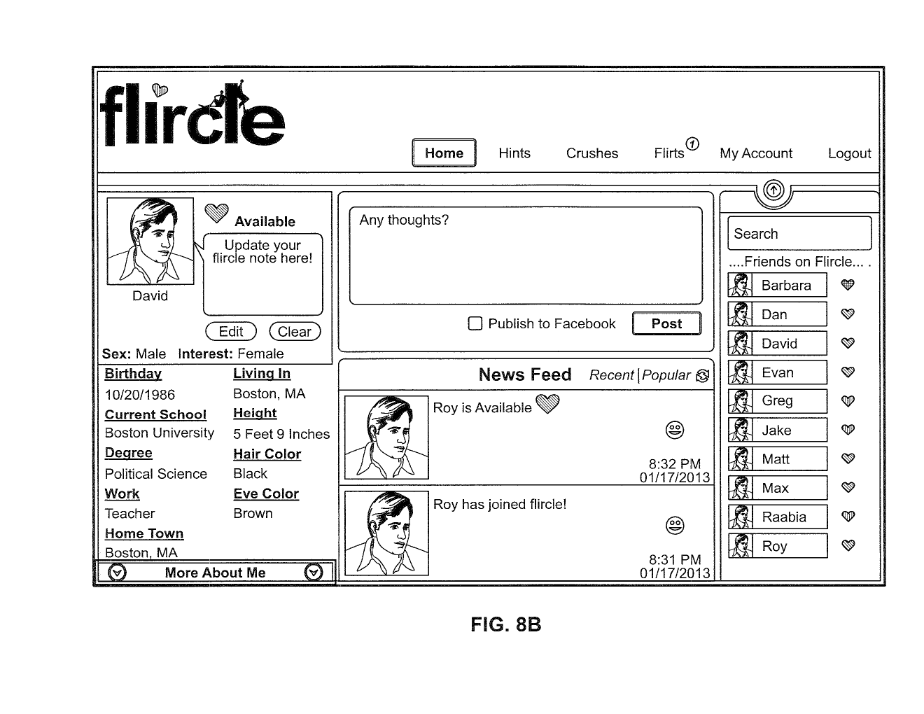

FIGS. 8A-8B illustrates how a user adds biographical information to the user account that is viewed by the additional user accounts.

FIG. 8A depicts the ability for a user to provide biographical information to be displayed on the user profile of the user's account. In this example, the “About Me” section 190 includes such biographical information as: interest, age, birthday, current school, degree, work, hometown, living in, religion, height, hair color, and eye color. Other examples include additional or alternative biographical information.

In this example, after a first user completes the biographical information, the first user clicks on an “apply” link 192 to submit the biographical information to the first user account 12. As shown in FIG. 8B, the submitted biographical information is displayed on the first user profile 16 of the first user account 12. The users within the predetermined group of accounts are able to view the biographical on the first user profile 16 of the first user account 12.

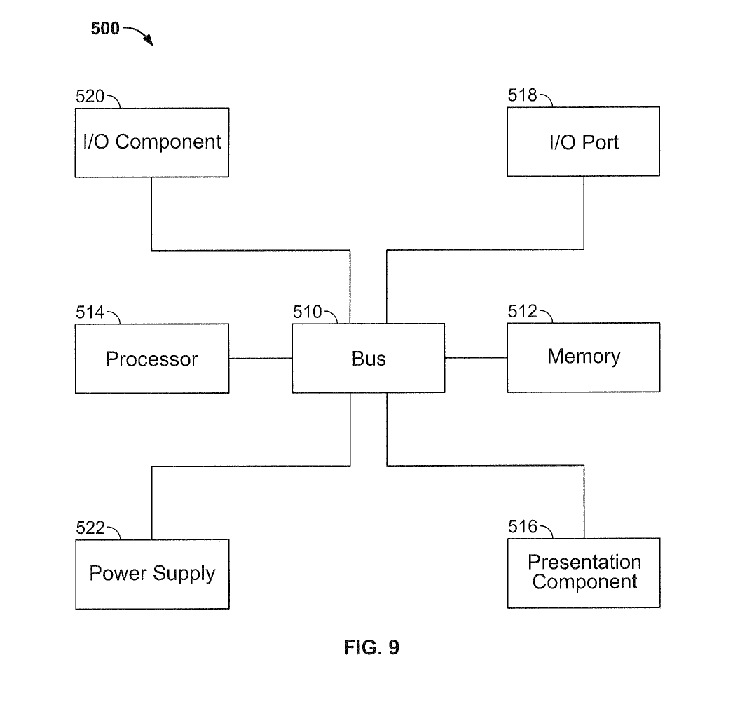

FIG. 9 illustrates an example of a computing device 500 for implementing aspects of the illustrative methods and systems of the present invention. The computing device 500 is merely an illustrative example of a suitable computing environment and in no way limits the scope of the present invention. A “computing device,” as represented by FIG. 9, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 522. One of skill in the art will appreciate that the bus 510 can include one or more busses, such as an address bus, a data bus, or any combination thereof. One of skill in the art additionally will appreciate that, depending on the intended applications and uses of a particular embodiment, multiple components can be implemented by a single device. Similarly, in some instances, a single component can be implemented by multiple devices. As such, FIG. 9 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 can be removable, non-removable, or any combination thereof.

Exemplary hardware devices are devices such as hard drives, solid-state memory, optical-disc drives, and the like.

The computing device 500 can include one or more processors 514 that read data from components such as the memory 512, the various I/O components 520, etc.

Presentation component(s) 516 present data indications to a user or other device. Exemplary presentation components 516 include a display device, speaker, printing component, vibrating component, etc.

The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, blue-tooth device, networking device, and the like.

One of skill in the art will appreciate a wide variety of ways to modify and alter the system and method of FIGS. 1-2, as well as the various components with which it interacts. For example, the one or more computing systems can be implemented according to any number of suitable computing system structures. Furthermore, some or all of the information contained in the one or more data stores alternatively can be stored in one or more remote databases (e.g., cloud databases, virtual databases, and any other remote database).

In some embodiments, it may be desirable to implement the method and system using multiple iterations of the depicted modules, controllers, and/or other components, as would be appreciated by one of skill in the art. Furthermore, while some modules and components are depicted as included within the system, it should be understood that, in fact, any of the depicted modules alternatively can be excluded from the system and included in a different system. One of skill in the art will appreciate a variety of other ways to expand, reduce, or otherwise modify the system upon reading the present specification.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method, comprising:
in one or more computing systems that collectively implement a social networking environment:
maintaining a first user account for a first user in one or more data stores of the one or more computing systems, the first user account having a first user augmented relationship indicator;
maintaining an additional account for each of a plurality of additional users in the one or more data stores of the one or more computing systems, each of the additional accounts having a bilaterally confirmed relationship connection with the first user account in such a way as to establish a predetermined group of accounts each having first degree account connections with the first user account for the first user within the social networking environment;
maintaining a second user account for a second user that is included in the predetermined group of accounts, the second user account having a second user augmented relationship indicator;
setting the first user augmented relationship indicator to indicate the second user account, thereby reflecting a desire of the first user to have an augmented relationship with the second user;
setting the second user augmented relationship indicator to indicate the first user account, thereby reflecting a desire of the second user to have an augmented relationship with the first user; and
the one or more computing systems establishing an augmented relationship connection between the first user account and the second user account in response to the setting of the first user augmented relationship indicator and the setting of the second user augmented relationship indicator, existence of the augmented relationship connection enabling additional functionality for interaction between the first user account and the second user account within the social networking environment;
wherein the setting of the first user augmented relationship indicator is not discoverable by the second user prior to the setting of the second user augmented relationship indicator of the second user account to indicate the first user account.

2. The method of claim 1, wherein the augmented relationship connection communicates existence of a romantic relationship between the first user and the second user, or existence of an adversarial relationship between the first user and the second user.

3. The method of claim 1, wherein the augmented relationship connection communicates existence of one or more of adverse, argumentative, belligerent, clashing, combative, conflicting, contentious, disputatious, quarrelsome, disagreeable, rancorous, affable, amiable, amicable, companionable, convivial, sociable, affectionate, amorous, romantic, and/or loving, relationship between the first user and the second user.

4. The method of claim 1, wherein the accounts for the first user, the second user, and the plurality of additional users comprise a relationship status indicator that indicates one of available, unsure, or taken, for each user.

5. The method of claim 1, wherein the first user account is synchronized with a second social networking environment.

6. The method of claim 5, wherein synchronization with the second social networking environment connects the first user account with a plurality of user profiles of users connected to the first user in the second social networking environment.

7. The method of claim 6, wherein at least one of the plurality of user profiles does not have an account in the social networking environment.

8. The method of claim 6, wherein a plurality of user profiles for users not having user accounts are displayed in a first display and a plurality of user profiles for users of the predetermined group of accounts are displayed in a second display.

9. The method of claim 1, wherein the additional functionality comprises displaying a pop-up notification window on the accounts of the first user and the second user notifying the users of the augmented relationship connection between the first user account and the second user account.

10. The method of claim 1, wherein setting the first user augmented relationship indicator to indicate the second user account designates a label of “hinting” for the second user account as viewed by the first user account.

11. The method of claim 1, wherein one or more user accounts having a designated label of “hinting” are defined as a subgroup of the predetermined group of accounts and are managed as a distinct group of user accounts connected with the first user account.

12. The method of claim 1, wherein the first user account further comprises a relationship status feed display providing only information related to one or more user accounts having a designated label of “hinting”.

13. The method of claim 1, further comprising setting a first user favorite indicator, of the first user account, to designate a label of “crush” for one or more of the additional user accounts.

14. The method of claim 1, wherein the first user account further comprises a relationship status feed display providing only information related to one or more user accounts having a designated label of “crush”.

15. The method of claim 1, wherein one or more user accounts having a designated label of “crush” are defined as a subgroup of the predetermined group of accounts and are managed as a distinct group of user accounts connected with the first user account.

16. The method of claim 1, wherein the first and second user accounts are designated with labels of “flirting” when the second user augmented relationship indicator is set to indicate the first user account after the first user augmented relationship indicator has been set to indicate the second user account.

17. The method of claim 1, wherein one or more user accounts having a designated label of “flirting” are defined as a subgroup of the predetermined group of accounts and are managed as a distinct group of user accounts connected with the first user account.

18. The method of claim 1, wherein the first user account further comprises a relationship status feed display providing only information related to one or more user accounts having a designated label of “flirting”.

19. The method of claim 1, wherein the social networking environment is a related-network of a second social networking environment, an application of a second social networking environment, or a subgroup within a second social networking environment.

20. The method of claim 1, further comprising sharing and communicating a plurality of activities by user accounts on the social networking environment to a second social networking environment.

21. The method of claim 20, wherein the sharing and communicating occurs via a link on a user account of the social networking environment.

22. A system for collectively implementing a social networking environment in one or more computing systems, the system comprising:
a first user account for a first user maintained in one or more data stores of the one or more computing systems, the first user account having a first user augmented relationship indicator;
a plurality of additional user accounts for a plurality of additional users maintained in the one or more data stores of the one or more computing systems, each of the plurality of additional user accounts having a bilaterally confirmed relationship connection with the first user account in such a way as to establish a predetermined group of accounts each having first degree account connections with first user account within the social networking environment;
a second user account for a second user that is included in the predetermined group of accounts, the second user account having a second user augmented relationship indicator;
wherein the first user augmented relationship indicator is set to indicate the second user account, thereby reflecting a desire of the first user to have an augmented relationship with the second user;
wherein the second user augmented relationship indicator is set to indicate the first user account, thereby reflecting a desire of the second user to have an augmented relationship with the first user;
wherein an augmented relationship connection established by the one or more computing systems between the first user account and the second user account in response to the setting of the first user augmented relationship indicator to indicate the second user account and the setting of the second user augmented relationship indicator to indicate the first user account, existence of the augmented relationship connection enabling additional functionality for interaction between the first user account and the second user account within the social networking environment; and
wherein the setting of the first user augmented relationship indicator is not discoverable by the second user prior to setting the second user augmented relationship indicator of the second user account to indicate the first user account.

23. The system of claim 22, wherein the accounts for the first user, the second user, and the plurality of additional users comprise a relationship status indicator configured to indicate one of available, unsure, or taken, for each user.

24. The system of claim 22, wherein the first user account is configured to synchronize with a second social networking environment.

25. The system of claim 22, wherein the additional functionality comprises a messaging function enabling communication via messaging between the first user account and the second user account, the additional functionality comprises a gaming function enabling electronic game play between the first user account and the second user account, or both.

26. The system of claim 22, wherein the social networking environment is linked directly from a second social networking environment.
